(19) United States
(12) Patent Application Publication
(10) Pub. No.: US 2007/0007891 A1
(43) Pub. Date: Jan. 11, 2007

(54) PLASMA DISPLAY PANEL

(75) Inventors: Tae-Woo KIM, Seoul (KR); Jeong-Nam KIM, Yongin-si (KR); Byoung-Min CHUN, Suwon-si (KR); Jeong-Doo YI, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD., Suwon-si (KR)

(21) Appl. No.: 11/428,662

(22) Filed: Jul. 5, 2006

(30) Foreign Application Priority Data
Jul. 6, 2005 (KR) 10-2005-0060662

(51) Int. Cl. H01J 1/62

(52) U.S. Cl. 313/509

(57) ABSTRACT

A high efficiency plasma display panel (PDP) that may be simply manufactured. The PDP includes a first substrate and a second substrate facing each other, a space between the first substrate and the second substrate is partitioned into discharge cells, a phosphor layer is formed within each discharge cell, electrodes participate in a discharge of each discharge cell, and a dielectric layer is formed on an external surface of at least one of the electrodes in a space between the first substrate and the second substrate. An alignment mark or a shaped alignment part is formed in the dielectric layer, and an alignment mark or a shaped alignment part corresponding to the alignment mark or the shaped alignment part of the dielectric layer is formed in at least one of the first substrate and the second substrate.

### CROSS-REFERENCE TO RELATED APPLICATION

This application claims priority to and the benefit of Korean Patent Application No. 10-2005-0060662, filed on Jul. 6, 2005, which is hereby incorporated by reference for all purposes as if fully set forth herein.

### BACKGROUND OF THE INVENTION

1. Field of the Invention

The present invention relates to a plasma display panel (PDP). More particularly, the present invention relates to a high efficiency plasma display panel that may be more simply manufactured.

2. Description of the Background

Generally, a plasma display panel (PDP) displays an image using visible light, which is generated when vacuum ultraviolet (VUV) rays, radiated by gas discharge, excite a phosphor. PDPs have been spotlighted as a future generation flat panel display because they may have a wide screen with high resolution.

A typical PDP structure includes a three electrode surface-discharge structure, which includes a front substrate and a rear substrate that are spaced apart by a predetermined distance from each other. Display electrode pairs are formed on the front substrate, and address electrodes are formed on the rear substrate. Barrier ribs partition a space between the two substrates into a plurality of discharge cells, a phosphor layer is formed on the rear substrate in each discharge cell, and a discharge gas is charged within each discharge cell.

An address discharge between one electrode of the display electrode pairs and an address electrode selects the corresponding discharge cell, and a sustain discharge is generated in selected discharge cells by the display electrodes, which are positioned on the same surface, to display an image. That is, in a conventional PDP, the address discharge is generated by an opposed discharge, and the sustain discharge is generated by a surface discharge. Generally, it is known that a higher voltage is required when a discharge is derived from the surface discharge rather than from the opposed discharge.

The PDP typically performs a discharge in several steps so as to display a predetermined image. However, because discharge efficiency in each step may be low, the PDP's efficiency, which is defined by a ratio of luminance to power consumption, may also be low.

Furthermore, an area of a phosphor layer that substantially contributes to light emission may be reduced if the PDP is not accurately aligned during manufacturing. Such misalignment further deteriorates the PDP's efficiency.

On the other hand, in the conventional PDP, electrodes may be manufactured by forming a conductive material on a substrate and then exposing and developing the conductive material. However, because this manufacturing method passes through several complicated processes, manufacturing productivity of the PDP deteriorates.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a plasma display panel (PDP) that may have improved light emitting efficiency. The present invention also provides a PDP that may be more simply manufactured, thereby reducing manufacturing cost.

Additional features of the invention will be set forth in the description which follows, and in part will be apparent from the description, or may be learned by practice of the invention.

The present invention discloses a plasma display panel including a first substrate and a second substrate that are arranged facing each other, discharge cells between the first substrate and the second substrate, a phosphor layer that is formed within each discharge cell, electrodes that participate in a discharge of each discharge cell, and a dielectric layer that is formed on an external surface of at least one of the electrodes in a space between the first substrate and the second substrate. An alignment mark or a shaped alignment part may be formed in the dielectric layer, and an alignment mark or a shaped alignment part corresponding to the alignment mark or the shaped alignment part of the dielectric layer may be formed in at least one of the first substrate and the second substrate.

The present invention also discloses a plasma display panel including a first substrate and a second substrate arranged facing each other with a plurality of discharge cells therebetween, and a layer arranged between the first substrate and the second substrate. The layer includes electrodes for generating a discharge in the discharge cells and a dielectric layer covering the electrodes. The layer includes a first alignment indicator, at least one of the first substrate and the second substrate includes a second alignment indicator, and the second alignment indicator is aligned with the first alignment indicator.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view showing a plasma display panel (PDP) according to a first exemplary embodiment of the present invention.

FIG. 2 is a partial exploded perspective view showing portion A of FIG. 1.

FIG. 3 is a partial cross-sectional view showing a coupled state of the PDP taken along line III-III of FIG. 2.

FIG. 4 is a flowchart showing a method of manufacturing the PDP according to an exemplary embodiment of the present invention.

FIG. 5 is a partial cross-sectional view showing a step of aligning a rear plate, a front plate, and a middle insertion layer in the PDP according to the first exemplary embodiment of the present invention.

FIG. 6 is a partial exploded perspective view showing a PDP according to an exemplary embodiment of the present invention.

FIG. 7 is a partial perspective view showing an electrode structure of the PDP of FIG. 6.

FIG. 8 is a plan view showing a front plate, a middle insertion layer, and a rear plate of a PDP according to a second exemplary embodiment of the present invention.

FIG. 9 is a plan view showing a coupled state of the front plate, the middle insertion layer, and the rear plate of FIG. 8.

FIG. 10 is a plan view showing a front plate, a middle insertion layer, and a rear plate of a PDP according to an exemplary embodiment of the present invention.

FIG. 11 is a partial exploded perspective view showing a coupled state of a front plate, a middle insertion layer, and a rear plate in portion D of FIG. 10.

### DETAILED DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

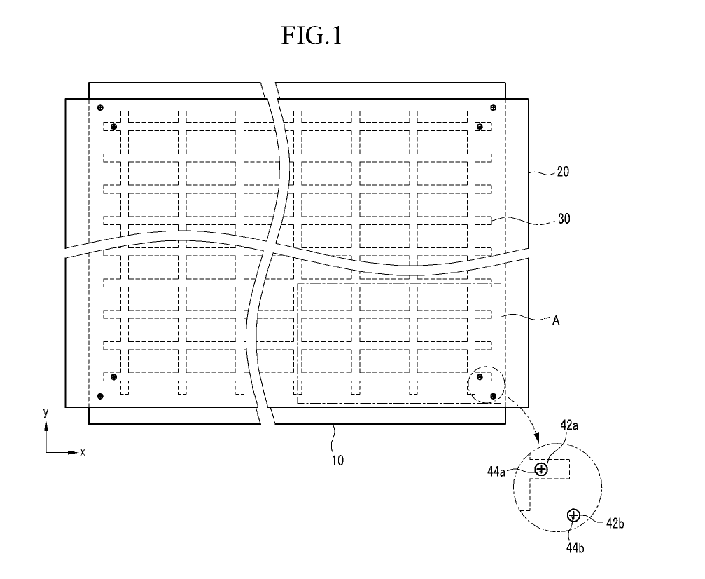

FIG. 1 is a plan view showing a plasma display panel (PDP) according to a first exemplary embodiment of the present invention.

Referring to FIG. 1, the PDP according to the present exemplary embodiment includes a rear plate 10 and a front plate 20 that are arranged opposite to, and spaced apart from, each other. A middle insertion layer 30 is interposed in a space between the rear plate 10 and the front plate 20. The middle insertion layer 30 includes electrodes and a dielectric layer that substantially surrounds the electrodes. Furthermore, the rear plate 10 and the front plate 20 may include a substrate and a phosphor layer, thereby forming a PDP by arranging the middle insertion layer 30 therebetween.

In the present exemplary embodiment, the first alignment mark 42a, which is formed in the front plate 20, and the second alignment mark 44a, which is formed in the middle insertion layer 30, are formed to correspond to each other, and the third alignment mark 44b, which is formed in the rear plate 10, and the fourth alignment mark 42b, which is formed in the front plate 20, are formed to correspond to each other. The alignment marks 42a, 42b, 44a, and 44b will be described below.

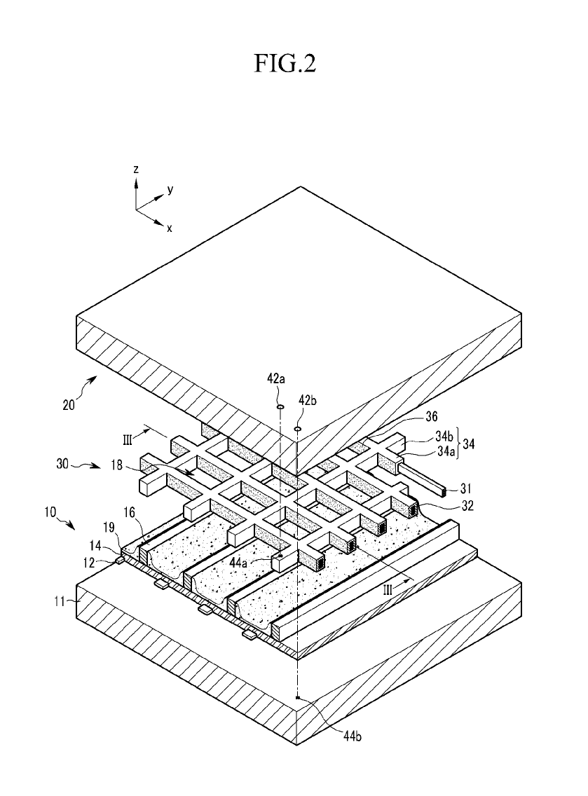

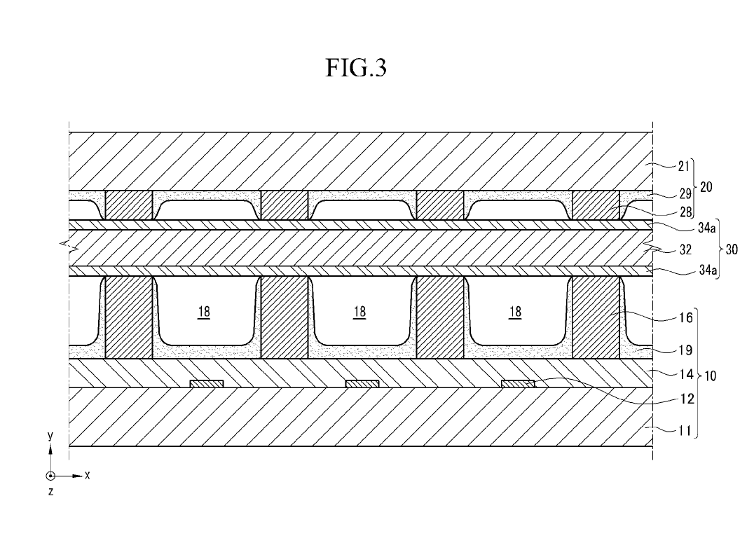

The PDP according to the first exemplary embodiment will be described in detail with reference to FIG. 2 and FIG. 3. FIG. 2 is a partial exploded perspective view showing portion A of FIG. 1, and FIG. 3 is a partial cross-sectional view showing a coupled state of the PDP taken along line III-III of FIG. 2.

Referring to FIG. 2 and FIG. 3, the rear plate 10 includes a rear substrate 11, address electrodes 12, a dielectric layer 14, barrier ribs 16, and a first phosphor layer 19.

The address electrodes 12 are arranged along a first direction (the y-axis direction in the drawings) on surface of the rear substrate 11, and the dielectric layer 14 is formed on the rear substrate 11 to substantially cover the address electrodes 12. Adjacent address electrodes 12 are spaced apart from each other by a predetermined distance.

The barrier ribs 16, which define discharge cells 18, are arranged along the first direction on the dielectric layer 14. The discharge cells 18 include a discharge gas (e.g., a mixed gas that may include xenon (Xe), neon (Ne), and so on) so that vacuum ultraviolet (VUV) rays may be generated by plasma discharge in each discharge cell 18.

Although striped barrier ribs 16 are shown in the present exemplary embodiment, the barrier ribs may have various structures. For example, the barrier ribs 16 may be formed in a matrix in which barrier rib members intersect each other, as well as in various other shapes. Furthermore, because the dielectric layer 34 of the middle insertion layer 30 is formed in a lattice, it performs a function of a barrier rib (i.e. partitioning the discharge cells 18). Therefore, a separate barrier rib need not be formed on the rear substrate 11.

A first phosphor layer 19 is arranged on the dielectric layer 14 and sides of the barrier ribs 16. The first phosphor layer 19 includes red, green, and blue light emitting phosphor layers, and it absorbs VUV rays that are generated by plasma discharge, thereby emitting visible light.

The front plate 20 includes a front substrate 21, a second phosphor layer 29, and a dark colored layer 28.

The second phosphor layer 29 is arranged on a surface of the front substrate 21 that faces the rear plate 10, and it corresponds to the first phosphor layer 19. For example, red, green, and blue light emitting portions of the second phosphor layer 29 may be individually and separately formed along the first direction. Portions of second phosphor layer 29 may be made of a phosphor material that generates the same color visible light as corresponding portions of first phosphor layer 19.

As shown in FIG. 3, the phosphor layers 19 and 29 are formed on the rear plate 10 and the front plate 20, respectively. Therefore, visible light may be generated at both sides of a discharge cell 18, thereby improving light emitting efficiency.

The dark colored layer 28 may be arranged along the first direction interspersed with the second phosphor layer 29. The dark colored layer 28 is arranged corresponding to the barrier ribs 16 of the rear plate 10, thereby preventing additional interception of visible light. Furthermore, the dark colored layer 28 may improve bright room contrast ratio by preventing reflection of external light.

The middle insertion layer 30 is interposed between the rear plate 10 and the front plate 20, and it includes display electrodes 31 and 32 and the dielectric layer 34. The display electrodes 31 and 32 and an address electrode 12 participate in a discharge of each discharge cell 18. The dielectric layer 34 is arranged on external surfaces of the display electrodes 31 and 32 to substantially surround them.

Here, the display electrodes 31 and 32 include a sustain electrode 31 and a scan electrode 32 arranged along a second direction (the x-axis direction in the drawings) intersecting the first direction. The scan electrode 32 and the address electrode 12 participate in an address discharge in an address period, thereby selecting discharge cells 18 to be turned-on. The sustain electrode 31 and the scan electrode 32 participate in a sustain discharge in a sustain period, thereby displaying a predetermined luminance. However, because electrode function may change depending on a signal voltage that is applied to each electrode, the present invention is not limited thereto.

In the present exemplary embodiment, the sustain electrode 31 and the scan electrode 32 are alternately arranged in the first direction. Here, a space that is formed by adjacent barrier ribs 16 in the second direction (the x-axis direction in the drawings) and an adjacent sustain electrode 31 and scan electrode 32 in the first direction (the y-axis direction in the drawings) define a discharge cell 18. In this case, one discharge cell 18 may form one subpixel, and a pair of adjacent discharge cells 18 in the first direction may form one subpixel.

Here, a subpixel is the smallest constituent element for selecting a discharge and thus emits visible light, and it generally emits visible light having one of the primary colors. Subpixels that discharge different colors may constitute one pixel. Here, a pixel is the smallest constituent element of a screen that may embody various colors and luminance. In the present exemplary embodiment, three subpixels for emitting, for example, green, red, and blue light, constitute one pixel, but more than three subpixels may constitute each pixel.

That is, when the sustain electrodes 31 are divided into an even-numbered sustain electrode group and an odd-numbered sustain electrode group, and a sustain voltage is applied to each sustain electrode group, each discharge cell 18 may constitute one subpixel. Furthermore, when a common voltage is applied to all sustain electrodes 31, the scan electrode 32 may be shared and a pair of discharge cells 18 adjacent in the first direction may constitute one subpixel.

The sustain electrode 31 and the scan electrode 32 are arranged opposing each other between the rear plate 10 and the front plate 20. Accordingly, a sustain discharge between the sustain electrode 31 and the scan electrode 32 may be derived by an opposed discharge, and a discharge firing voltage, which is required for plasma discharge, may be reduced. In the present exemplary embodiment, the sustain electrode 31 and the scan electrode 32 are positioned at the side of the discharge cell 18. Therefore, electrodes that may hinder transmission of visible light are not positioned on the front plate 20, thereby increasing the PDP's aperture ratio. Furthermore, the PDP's efficiency may be improved.

The present invention is not limited by the structure and arrangement of the sustain electrode 31 and the scan electrode 32. That is, various structures, such as a structure in which a pair of display electrodes are separately formed, may be formed in each discharge cell.

The dielectric layer 34 is arranged on external surfaces of the sustain electrode 31 and the scan electrode 32. The dielectric layer 34 includes a first portion 34a, which is arranged in the second direction while substantially surrounding each of the sustain electrode 31 or the scan electrode 32, and a second portion 34b, which is arranged in the first direction to intersect the first portion 34a. The second portion 34b of the dielectric layer 34 may be arranged corresponding to the barrier rib 16.

The dielectric layer 34 protects the sustain electrode 31 and the scan electrode 32 from damage due to collision with ions that are formed during plasma discharge Furthermore, the dielectric layer 34 forms and accumulates wall charges depending on a voltage that is applied to the sustain electrode 31 or the scan electrode 32. Also, as described above, the dielectric layer 34 may perform a function of a barrier rib (e.g. partitioning a discharge space between the rear plate 10 and the front plate 20).

A protective layer 36 may be arranged on a portion of the dielectric layer 34 that is exposed to plasma discharge, and in the present exemplary embodiment, the protective layer 36 is arranged on the side of the discharge cell 18. The protective layer 36 protects the dielectric layer 34 from collision with ions that are ionized by plasma discharge. Furthermore, because the protective layer 36 may be made of a material having a high secondary electron emission coefficient, it emits secondary electrons, thereby improving discharge efficiency.

Here, because the protective layer 36 is arranged at the side of the discharge cell 18, it may be made of a non-transparent material. For example, the protective layer 36 may be made of non-transparent MgO. Because non-transparent MgO has a much higher secondary electron emission coefficient than transparent MgO, discharge efficiency may be further improved.

The middle insertion layer 30, which includes the display electrodes 31 and 32 and the dielectric layer 34, may be separately manufactured with a thick film ceramic sheet (TFCS) method, etc. Thereafter, the middle insertion layer 30 may be coupled between the rear plate 10 and the front plate 20. The TFCS method may be used to form both an electrode and a dielectric layer. That is, the TFCS method includes a process of printing a dielectric material paste and a conductive material paste, and a process of surrounding external surfaces with a dielectric material, and both the electrode and the dielectric layer may be formed with the method. A manufacturing process of the middle insertion layer 30 will be described in detail below.

As FIG. 1 and FIG. 2 show, the first alignment mark 42a and the fourth alignment mark 42b are formed near each corner of the front substrate 21. While the fourth alignment mark 42b is formed closer to each corner of the front substrate 21 than the first alignment mark 42a, other arrangements are possible.

The second alignment mark 44a is formed in the dielectric layer 34 of the middle insertion layer 30. That is, the second alignment mark 44a is formed in a position of the dielectric layer 34 that corresponds to the first alignment mark 42a. Furthermore, the third alignment mark 44b is formed in the rear substrate 11 of the rear plate 10. That is, the third alignment mark 44b is formed in a position of the rear substrate 11 that corresponds to the fourth alignment mark 42b.

The front plate 20 and the middle insertion layer 30 may be aligned by using the first alignment mark 42a and the second alignment mark 44a, and the front plate 20 and the rear plate 10 may be aligned by using the fourth alignment mark 42b and the third alignment mark 44b. Here, the fourth alignment mark 42b is shown formed in the front plate 20, and the rear plate 10 is aligned using the front plate 20. However, the fourth alignment mark may alternatively be formed in the middle insertion layer 30, and the rear plate 10 may be aligned using the middle insertion layer 30.

The alignment marks 42a, 42b, 44a, and 44b are formed in a non-display area of the PDP so that they do not block otherwise visible light that is generated by plasma discharge. Here, the non-display area is an area that is formed along an outer portion of a display area, i.e., an edge portion of a panel in which the display is substantially performed. Specifically, the non-display area may include a dummy area in which dummy cells are arranged and a terminal area for connecting inner electrodes and an outer terminal.

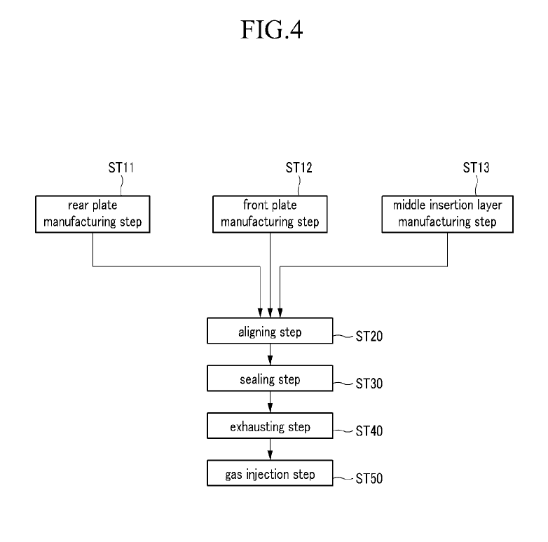

FIG. 4 shows a manufacturing method of the PDP according to an exemplary embodiment of the present invention. Referring to FIG. 4, the method includes the steps of manufacturing a rear plate (ST11), manufacturing a front plate (ST12), manufacturing a middle insertion layer (ST13), and aligning the rear plate, front plate, and middle insertion layer (ST20). The manufacturing method may further include the steps of sealing the PDP (ST30), exhausting air from a space between the rear substrate and the front substrate (ST40), and injecting a discharge gas into the discharge cells (ST50).

Here, various well-known methods may be applied in the sealing step (ST30), the exhaust step (ST40), and the gas injection step (ST50), and thus detailed descriptions thereof will be omitted. The steps of manufacturing the middle insertion layer (ST13) and aligning (ST20) will be described in detail below.

Referring again to FIG. 2, the steps of manufacturing the rear plate 10 (ST11), manufacturing the front plate 20 (ST12), and manufacturing the middle insertion layer 30 (ST13) will be described.

The address electrodes 12, the dielectric layer 14, the barrier ribs 16, and the first phosphor layer 19 are sequentially formed on the rear substrate 11, thereby manufacturing the rear plate 10. Furthermore, the second phosphor layer 29 and the dark colored layer 28 are formed on the front substrate 21, thereby manufacturing the front plate 20. The first alignment mark 42a and the fourth alignment mark 42b are formed in the non-display area of the front substrate 21, and the third alignment mark 44b is formed on the rear substrate 11 in a position corresponding to the fourth alignment mark 42b.

The middle insertion layer 30, which includes the display electrodes 31 and 32 and the dielectric layer 34, may be manufactured using a TFCS method. The second alignment mark 44a is formed in a position corresponding to the first alignment mark 42a.

When utilizing the TFCS method, a support body including a substrate and a peeling layer is prepared. Thereafter, a screen mask having a lattice opening is positioned on the peeling layer, and a dielectric material paste is coated thereon using a printing method. Next, a screen mask having an electrode-shaped opening is positioned on the dielectric material paste, and the conductive material paste is coated thereon using a printing method. Then, a pattern of the dielectric layer/conductive layer is formed by baking the dielectric material paste and the conductive material paste. In the baking process, because the peeling layer may change to a particle layer that is free from each other, the pattern of the dielectric layer/conductive layer may be easily separated from the substrate. After separating the pattern of the dielectric layer/conductive layer from the substrate, the separated pattern is soaked in a tub that is filled with the dielectric material paste. Thereafter, as the pattern of the dielectric layer/conductive layer is taken from the tub, the middle insertion layer 30 of a lattice format, in which a dielectric layer is substantially formed on an entire external surface, may be formed.

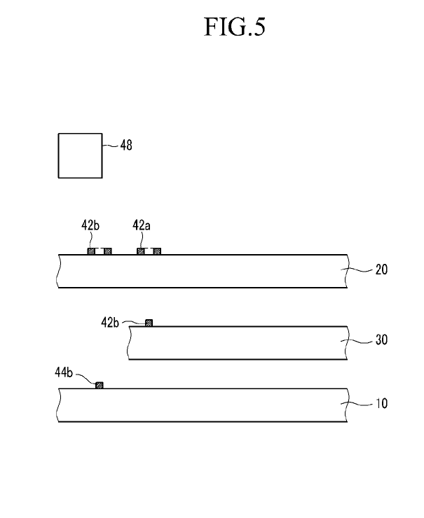

The step (ST20) of aligning the rear plate 10, the front plate 20, and the middle insertion layer 30 will now be described. FIG. 5 is a partial cross-sectional view showing a step of aligning the rear plate, the front plate, and the middle insertion layer in the PDP according to the first exemplary embodiment of the present invention.

As shown in FIG. 5, the middle insertion layer 30 is positioned between the rear plate 10 and the front plate 20.

Optical equipment 48 is spaced a predetermined distance apart from the front plate 20. By using the optical equipment 48, it may be determined that the front plate 20 and the middle insertion layer 30 are aligned when the first alignment mark 42a and the second alignment mark 44a are arranged in the same position when viewed from the front of the front plate 20. Likewise, the rear plate 10 and the front plate 20 may be aligned when the third alignment mark 44b and the fourth alignment mark 42b are arranged in the same position, which may be determined by using the optical equipment 48.

Here, the middle insertion layer 30 is separately manufactured and then coupled to the rear plate 10 and the front plate 20, thereby manufacturing the PDP. Therefore, because the PDP may be manufactured with a relatively simple method, its manufacturing cost may be reduced.

In the present exemplary embodiment, the alignment mark 44a is formed in the middle insertion layer 30, thereby improving alignment accuracy. Alignment of the rear plate 10, the middle insertion layer 30, and the front plate 20 is related to alignment of the display electrodes 31 and 32 of the middle insertion layer 30 and the phosphor layers 19 and 29 of the rear plate 10 and the front plate 20, respectively. Therefore, as alignment may be more accurately performed, the phosphor layers 19 and 29 may have a wider area that may contribute to light emission. Accordingly, the PDP's efficiency may improve.

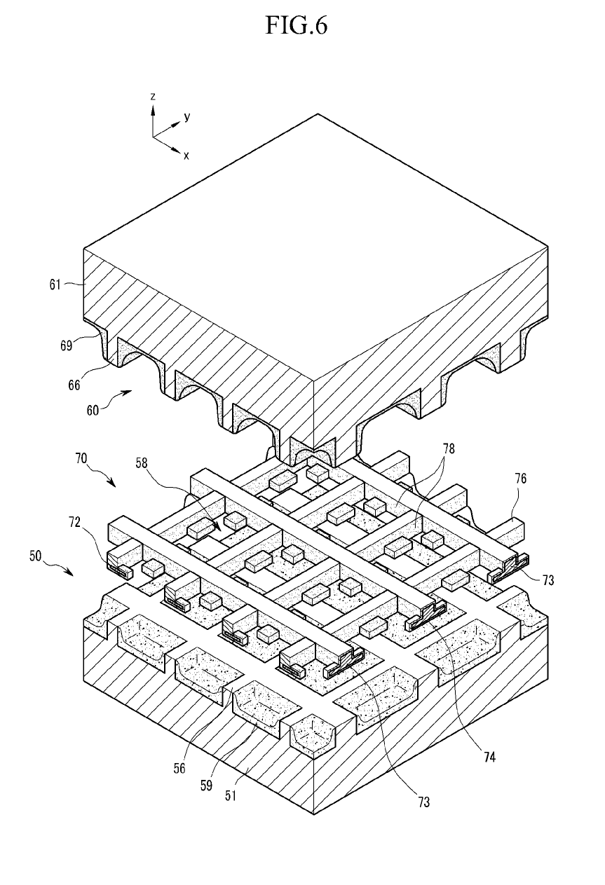

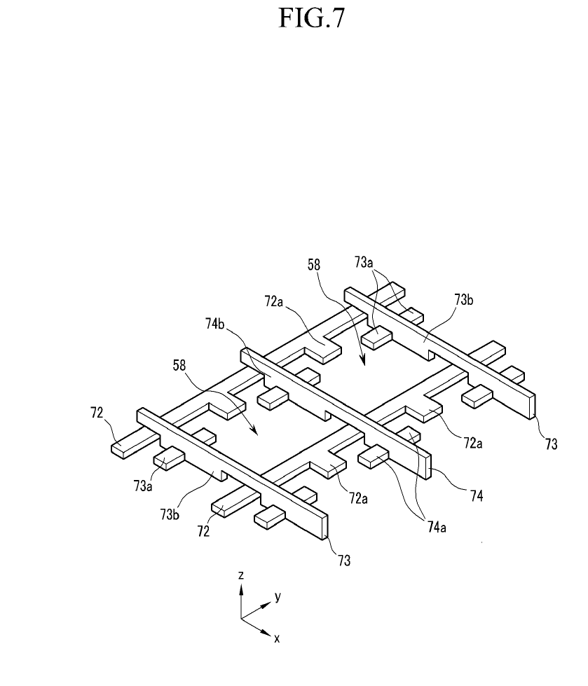

In the present exemplary embodiment, the address electrodes 12 are positioned on the rear substrate 11 and the display electrodes 31 and 32 are formed within the dielectric layer 34 of the middle insertion layer 30. However, other configurations are possible. For example, as FIG. 6 and FIG. 7 show, both the address electrode and the display electrode may be positioned within the dielectric layer of the middle insertion layer.

The PDP of FIG. 6 and FIG. 7 has a similar basic structure to that of the first exemplary embodiment of the present invention, and thus detailed descriptions regarding the same or similar parts thereof will be omitted, and portions different from those of the first exemplary embodiment will be described in detail. A non-display area in which the alignment marks are formed may have basically the same structure as that of the first exemplary embodiment, and thus description thereof will be omitted.

FIG. 6 is a partial exploded perspective view showing a PDP according to an exemplary variation of the first exemplary embodiment of the present invention, and FIG. 7 is a partial perspective view showing an electrode structure of the PDP of FIG. 6.

Referring to FIG. 6 and FIG. 7, the PDP includes the rear plate 50 and the front plate 60 that are spaced apart from and facing each other. The middle insertion layer 70 is interposed between the rear plate 50 and the front plate 60.

Here, a rear substrate 51 and a rear-plate barrier rib 56 of the rear plate 50 are formed of the same material in a single structure. The phosphor layer 59 is arranged on a surface of the rear substrate 51 and sides of the rear-plate barrier rib 56. The rear substrate 51 and the rear-plate barrier rib 56 may be manufactured by etching a glass substrate and so on to correspond to a shape of each discharge cell 58, which may reduce a manufacturing process and manufacturing cost.

Likewise, a front substrate 61 and a front-plate barrier rib 66 of the front plate 60 are formed of the same material in a single structure. A phosphor layer 69 is arranged on a surface of the front substrate 61 and sides of the front-plate barrier rib 66. The front substrate 61 and the front-plate barrier rib 66 may be manufactured by etching a glass substrate and so on to correspond to a shape of each discharge cell 58.

While FIG. 6 shows the rear-plate barrier rib 56 and the front-plate barrier rib 66 with a matrix structure, the barrier ribs may have various structures, such as a stripe shape. Furthermore, because the middle insertion layer 70 may function as a barrier rib, a separate barrier rib need not be formed.

The middle insertion layer 70 is arranged between the rear plate 50 and the front plate 60. The middle insertion layer 70 includes an address electrodes 72, display electrodes 73 and 74, and a dielectric layer 76. The dielectric layer 76 substantially surrounds the address electrodes 72 and the display electrodes 73 and 74, and a protective layer 78 may be formed on portions of the dielectric layer 76.

The address electrodes 72 are arranged along the first direction within the dielectric layer 76, and the display electrodes 73 and 74 are arranged along the second direction to intersect the first direction. Furthermore, the display electrodes 73 and 74 are electrically insulated from the address electrode 72.

Here, a space formed by adjacent barrier ribs 56 and 66 in the second direction (the x-axis direction in the drawings), and an adjacent sustain electrode 73 and scan electrode 74 in the first direction (the y-axis direction in the drawings), is defined as a discharge cell 58. In this case, one discharge cell 58 may form one subpixel, and a pair of adjacent discharge cells 58 in the first direction may form one subpixel.

The address electrode 72 includes a protruding portion 72a that protrudes between the sustain electrode 73 and the scan electrode 74. The protruding portion 72a applies address pulses, which are applied to the address electrode 72, to the discharge cell 58. Furthermore, the protruding portion 72a forms a short discharge gap between the address electrode 72 and the scan electrode 74 within the discharge cell 58. Consequently, with the short discharge gap, an address discharge voltage may be lowered.

Referring to FIG. 7, the sustain electrode 73 and the scan electrode 74 include extending portions 73b and 74b, respectively. The extending portions 73b and 74b correspond to each discharge cell 58, and they extend in a vertical direction (the z-axis direction in the drawings) with respect to the rear substrate 51. The extending portions 73b and 74b permit occurrence of an opposed discharge in a wider area, which may generate strong VUV rays. The strong VUV rays may collide with phosphor layers 59 and 69 over a wide area within the discharge cell 58, thereby increasing the amount of visible light.

Accordingly, because the sustain electrode 73 and the scan electrode 74 are arranged to cross the address electrode 72 and include the extending portions 73b and 74b, a smooth crossing arrangement without interference with the address electrode 72 may be possible.

The sustain electrode 73 and the scan electrode 74 may further include protruding portions 73a and 74a, respectively. A discharge gap between the protruding part 72a of the address electrode 72 and the protruding portion 74a of the scan electrode 74 is formed as a shorter gap, thereby permitting an address discharge with a low voltage. Furthermore, the protruding portion 73a of the sustain electrode 73 and the protruding portion 74a of the scan electrode 74 provide for a shorter discharge gap between the sustain electrode 73 and the scan electrode 74. Therefore, at initial discharge, a sustain discharge may be performed with a low voltage, and then a sustain discharge of a long gap is generated, thereby improving light emitting efficiency.

The present exemplary embodiment shows an example in which the address electrode 72 and the display electrodes 73 and 74 are formed within the middle insertion layer 70, yet various additional structures may be utilized. For example, at least one of the address electrode and the display electrodes may be positioned within the middle insertion layer.

A PDP and a manufacturing method thereof according to a second exemplary embodiment of the present invention and an exemplary variation thereof will be described below. The present exemplary embodiment and the exemplary variation thereof are substantially the same as or similar to the first exemplary embodiment of the present invention and the exemplary variation thereof, thus detailed descriptions thereof will be omitted, and different parts will be described in detail.

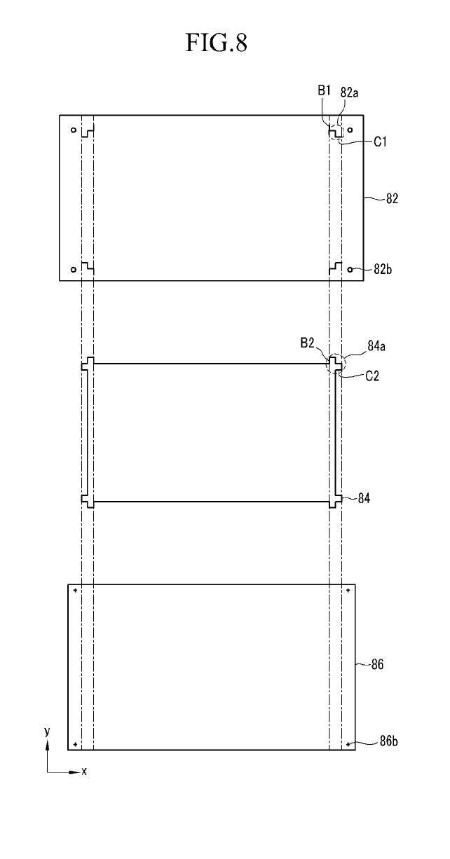

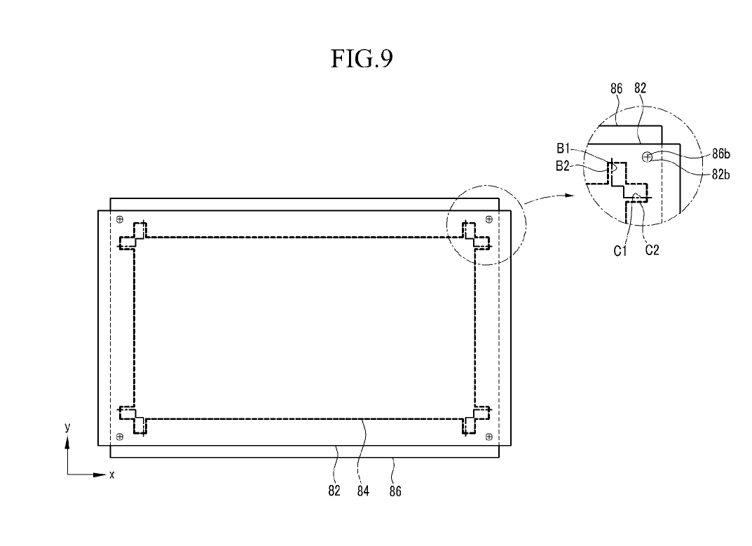

FIG. 8 is a plan view showing a front plate, a middle insertion layer, and a rear plate of a PDP according to the second exemplary embodiment of the present invention, and FIG. 9 is a plan view showing a coupled state of the front plate, the middle insertion layer, and the rear plate of FIG. 8. The middle insertion layer is not shown with an electrode. Rather, it is shown as a dielectric layer because electrodes of several structures may be formed inside it.

Referring to FIG. 8, a first shaped alignment part 82a is formed near a corner of a front plate 82 (i.e. a corner of the front substrate). The shaped alignment part is formed in a shape for alignment. For example, the first shaped alignment part of FIG. 8 is formed in a stair shape. The shaped alignment part may be formed with various methods. For example, the shaped alignment part may be formed on a substrate using laser or by etching a part of the substrate. Furthermore, although the shaped alignment part of FIG. 8 is formed in a stair shape, various shapes capable for use in aligning the middle insertion layer and the front plate, or the rear plate and the front plate, may be formed on the front plate. An alignment mark 82b is also formed on the front plate 82. The alignment mark 82b is an indicator that is used in aligning the front plate and the rear plate, or the front plate and the middle insertion later. Furthermore, the alignment mark 82b may be also formed with various methods, i.e., using laser method or etching method.

On the other hand, a second shaped alignment part 84a is formed at a corner of the middle insertion layer 84 (i.e. at each corner of a dielectric layer surrounding the electrode). Here, the second shaped alignment part 84a includes a shape of a protruding portion that protrudes toward the outside of the middle insertion layer 84.

An alignment mark 86b is formed near a corner of the rear plate 86 (i.e. at a corner of the rear substrate). Here, the alignment mark 86b is formed at a position corresponding to the alignment mark 82b formed on the front plate 82.

As shown in FIG. 9, the first shaped alignment part 82a, which is formed on the front plate 82, and the second shaped alignment part 84a, which is formed on the middle insertion layer 84, have different shapes. However, when viewed from the front of the front plate 82, at least one edge (B1, C1) of the first shaped alignment part 82a and at least one edge (B2, C2) of the second shaped alignment part 84a may be formed and arranged to correspond with each other.

That is, when viewed from the front of the front plate 82, an edge B1 of the first shaped alignment part 82a that is formed along the first direction and an edge B2 of the second shaped alignment part 84a that is also formed along the first direction are formed and arranged to correspond with each other. Furthermore, when viewed from the front of the front plate 82, another edge C1 of the first shaped alignment part 82a that is formed along the second direction and another edge C2 of the second shaped alignment part 84a that is also formed along the second direction are formed and arranged to correspond with each other.

Optical equipment (not shown) may be provided to the entire surface of the front plate 82 for aligning the first and second shaped alignment parts 82a and 84a and the alignment marks 82b and 86b.

In the present exemplary embodiment, alignment marks 82b and 86b are formed on the front plate 82 and the rear plate 86, respectively, and the front plate 82 is aligned with the rear plate 86. However, an alignment mark may alternatively be formed in a dielectric layer of the middle insertion layer 84, and the rear plate 86 may be aligned using the middle insertion layer 84.

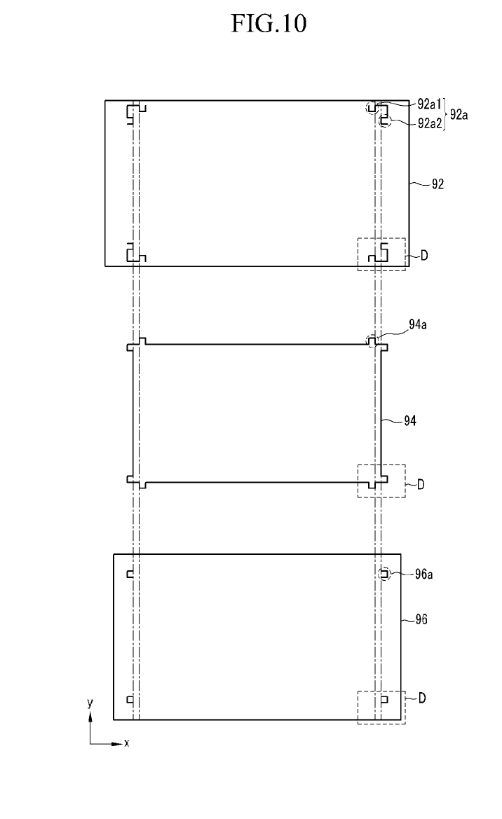

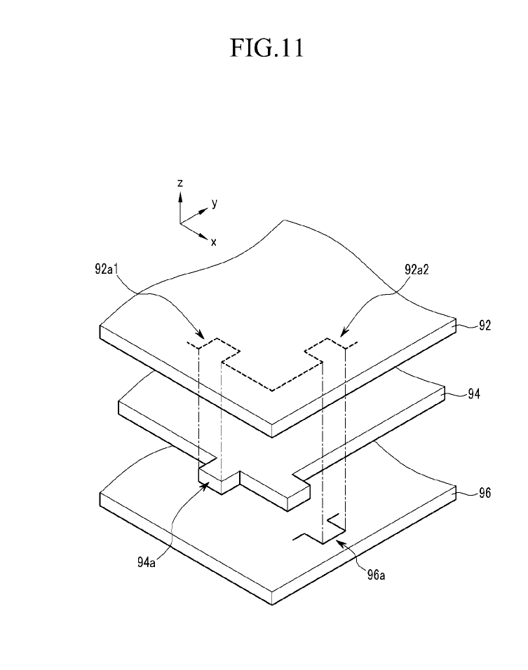

FIG. 10 is a plan view showing a front plate, a middle insertion layer, and a rear plate of a PDP according to an exemplary variation of the second exemplary embodiment of the present invention, and FIG. 11 is a partial exploded perspective view showing a coupled state of the front plate, the middle insertion layer, and the rear plate in portion D of FIG. 10.

In the present exemplary embodiment, first, second, and third shaped alignment parts 92a, 94a, and 96a are formed at each corner of the front plate 92, the middle insertion layer 94, and the rear plate 96, respectively.

Referring to FIG. 10, the first shaped alignment part 92a is provided at four corners of the front plate 92. The second shaped alignment part 94a is formed at both edges that are formed along the second direction (the x-axis direction in the drawings) of the middle insertion layer 94, and the second shaped alignment part 94a has a shape of a protruded portion that protrudes toward the first direction (the y-axis direction of the drawings). Furthermore, the third shaped alignment part 96a is formed at both edges that are formed along the first direction (the y-axis direction in the drawings) of the rear plate 96, and the third shaped alignment part 96a has a shape of a protruded portion that protrudes toward the second direction (the x-axis direction in the drawings). Each shape of the second shaped alignment part 94a and the third shaped alignment part 96a is formed to correspond to a shape of the first shaped alignment part 92a.

Here, as shown in FIG. 11, a shaped side part 92a1 of the first shaped alignment part 92a and the second shaped alignment part 94a are formed and arranged in a position corresponding to each other, when viewed from the front of the front plate 92. The other shaped side part 92a2 of the first shaped alignment part 92a and the third shaped alignment part 96a are formed and arranged in a position to correspond to each other. Accordingly, the first, second, and third shaped alignment parts 92a, 94a, and 96a may be formed to engage with each other, when viewed from the front.

That is, in order to align the PDP, corresponding edges of the first shaped alignment part 92a, the second shaped alignment part 94a, and the third shaped alignment part 96a are adjusted to correspond to each other, when viewed from the front of the front plate 92.

Accordingly, alignment accuracy of the front plate, the middle insertion layer, and the rear plate may be improved. Furthermore, a wider portion of the phosphor layer may contribute to light emission, thereby improving efficiency.

In a PDP according to exemplary embodiments of the present invention, an electrode may have various structures in addition to the above-mentioned structures, and the rear plate and the front plate may also have various structures in addition to the above-mentioned structure. While manufacturing the middle insertion layer is described with only a process of manufacturing with a TFCS method, the middle insertion layer may be manufactured with other methods.

An alignment mark and a shaped alignment part may have various shapes and positions.

Furthermore, in the above description, although it is described that optical equipment is used with an alignment method, various equipment may be used to detect an alignment state of the alignment mark and the shaped alignment part.

As described above, the PDP according to an exemplary embodiment of the present invention may include a middle insertion layer that is coupled between the rear plate and the front plate after separately manufacturing it. Accordingly, the PDP's manufacturing cost may be reduced.

As noted above, an alignment mark or a shaped alignment part may be formed in the middle insertion layer, so that the middle insertion layer may be more accurately aligned. Accordingly, an area of a phosphor layer to contribute to light emission may be more extensively formed, thereby improving the PDP's reliability.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel, comprising:
a first substrate and a second substrate arranged opposing each other;
discharge cells between the first substrate and the second substrate;
a phosphor layer arranged in the discharge cells;
electrodes that participate in a discharge of the discharge cells; and
a dielectric layer arranged on an external surface of at least one of the electrodes, the dielectric layer and the at least one electrode being arranged in a space between the first substrate and the second substrate,
wherein the dielectric layer comprises an alignment mark or a shaped alignment part, and
at least one of the first substrate and the second substrate comprises an alignment mark or a shaped alignment part corresponding to the alignment mark or the shaped alignment part of the dielectric layer, respectively.

2. The plasma display panel of claim 1, wherein the second substrate comprises a first alignment mark, and
the dielectric layer comprises a second alignment mark, the second alignment mark corresponding to the first alignment mark.

3. The plasma display panel of claim 2, wherein the first substrate comprises a third alignment mark, and
the second substrate or the dielectric layer comprises a fourth alignment mark, the fourth alignment mark corresponding to the third alignment mark.

4. The plasma display panel of claim 3, wherein the second substrate comprises the first alignment mark and the fourth alignment mark, and
in each corner of the second substrate, the fourth alignment mark is arranged closer to the corner than the first alignment mark.

5. The plasma display panel of claim 1, wherein the second substrate comprises a first shaped alignment part, and the dielectric layer comprises a second shaped alignment part, the second shaped alignment part having a different shape than the first shaped alignment part, and
at least one edge of the first shaped alignment part and at least one edge of the second shaped alignment part correspond with each other, when viewed from the front of the second substrate.

6. The plasma display panel of claim 5, wherein the first substrate comprises a third shaped alignment part, the third shaped alignment part having a different shape than the first shaped alignment part or the second shaped alignment part, and
at least one edge of the third shaped alignment part and at least one edge of the first shaped alignment part or the second shaped alignment part correspond with each other, when viewed from the front of the second substrate.

7. The plasma display panel of claim 5, wherein the first substrate comprises a first alignment mark, and the second substrate or the dielectric layer comprises a second alignment mark, the second alignment mark corresponding to the first alignment mark.

8. The plasma display panel of claim 1, wherein the second substrate comprises a first shaped alignment part, and
the dielectric layer comprises a second shaped alignment part, the second shaped alignment part having a shape corresponding to a shape of the first shaped alignment part.

9. The plasma display panel of claim 8, wherein the first shaped alignment part and the second shaped alignment part are arranged to be engaged with each other, when viewed from the front of the second substrate.

10. The plasma display panel of claim 8, wherein the first substrate comprises a third shaped alignment part, the third shaped alignment part having a shape corresponding to a shape of the first shaped alignment part or the second shaped alignment part.

11. The plasma display panel of claim 10, wherein one side of the first shaped alignment part and the second shaped alignment part are arranged to be engaged with each other, and the other side of the first shaped alignment part and the third shaped alignment part are arranged to be engaged with each other, when viewed from the front of the second substrate.

12. The plasma display panel of claim 1, wherein the dielectric layer comprises a first part that extends along one direction and a second part that intersects the first part.

13. The plasma display panel of claim 1, wherein the electrodes comprise a display electrode and an address electrode, the display electrode extends along one direction within the dielectric layer, and the address electrode is arranged on the first substrate or the second substrate and crosses with the display electrode.

14. The plasma display panel of claim 1, wherein the electrodes comprise a display electrode and an address electrode, the display electrode extends along one direction within the dielectric layer, and the address electrode crosses with the display electrode while being electrically insulated from the display electrode and arranged within the dielectric layer.

15. The plasma display panel of claim 1, wherein the dielectric layer and electrodes arranged within the dielectric layer are formed with a thick film ceramic sheet method.

16. A plasma display panel, comprising:
a first substrate and a second substrate arranged facing each other with a plurality of discharge cells therebetween;
a layer arranged between the first substrate and the second substrate, the layer comprising electrodes for generating a discharge in the discharge cells and a dielectric layer substantially surrounding the electrodes;
wherein the layer comprises a first alignment indicator, at least one of the first substrate and the second substrate comprises a second alignment indicator, and the second alignment indicator is aligned with the first alignment indicator.

17. The plasma display panel of claim 16, wherein the first alignment indicator is an alignment mark arranged on the dielectric layer, and the second alignment indicator is an alignment mark on the first substrate.

18. The plasma display panel of claim 17, further comprising a third alignment indicator and a fourth alignment indicator, the third alignment indicator being an alignment mark arranged on the first substrate and the fourth alignment indicator being an alignment mark arranged on the second substrate,
wherein the third alignment indicator is aligned with the fourth alignment indicator.

19. The plasma display panel of claim 16, wherein the first alignment indicator is a shaped alignment part arranged at a corner of the layer, and the second alignment indicator is a shaped alignment part arranged at a corner of the first substrate.

20. The plasma display panel of claim 19, further comprising a third alignment indicator and a fourth alignment indicator, the third alignment indicator being an alignment mark arranged on the first substrate and the fourth alignment indicator being an alignment mark arranged on the second substrate,
wherein the third alignment indicator is aligned with the fourth alignment indicator.
